(19) United States
(12) Patent Application Publication
(10) Pub. No.: US 2004/0011172 A1
(43) Pub. Date: Jan. 22, 2004

(54) Stacking machine and method

(76) Inventors: David S. Rosenthal, Highland Park, IL (US); Gregory Starr, Buffalo Grove, IL (US)

Correspondence Address: OLSON & HIERL, LTD., 36th Floor, 20 Norh Wacker Drive, Chicago, IL, 60606, US

(21) Appl. No.: 10/199,339

(22) Filed: Jul. 19, 2002

(51) Int. Cl. B26D 7/06

(52) U.S. Cl. 83/29; 83/436.3

(57) ABSTRACT

A method of automatic in-line forming of a material stack comprising the steps of feeding a base in sheet form or from a roll to a predetermined position, simultaneously feeding a first layer from a first roll for placement on one side of the base in sheet form and a second layer from a second roll for placement on the opposite side of the base in sheet form. The base, the first layer from the first roll, and the second layer from the second roll are moved together to a cutting station and are advanced a predetermined length. The first layer and the second layer are cut together to the predetermined length to form the desired stack, with the base between the first and second layers. In another aspect, the invention comprises apparatus for automatic in-line forming of a material stack comprising a main frame, a conveyor on the main frame for feeding a base material. A first layer of material is fed from a first roll onto one surface of the base material. A second layer of material is fed from a second roll to the opposite surface of the base. A third roll can be provided from which a third layer is fed onto the first layer. Pinch rollers are provided for moving the base material, the first layer, the second layer and the third layer to a cutting station. A gripper mechanism is associated with the pinch rollers for pulling out a predetermined length of material to be cut when the pinch rollers are released. A fixed blade is provided on one side of the stack and a movable blade is provided on the other side of the stack. The movable blade cooperates with the fixed blade for cutting the predetermined length of material together to form the desired stack of material on both sides of the base material. Controls are provided for coordinating the operation of the pinch rollers, the gripper mechanism, and the fixed and movable blades.

### BACKGROUND OF THE INVENTION

The present invention pertains to an automatic in-line stacking apparatus and method of automatic in-line stacking, and more particularly, automatic in-line stacking apparatus and method for stacking material on opposite sides of a base.

In the past, several known processes of stacking material for various industrial applications has been by hand or by use of pick and place machines. For example, to fabricate a solar panel, discrete layers of material were cut to size, then the discrete layers were stacked by hand or by use of a pick and place machine. The stack could then be subject to another process, for example, lamination of the constituent layers together by heat and pressure, to form the completed solar panel. Recently, solar panels have been developed that are flexible and are made from materials having different properties and characteristics. It is desired to integrate these material efficiently into a solar panel in as expeditious a fashion as possible.

An object of the present invention is to provide an automatic in-line stacking apparatus and method that overcomes the disadvantages of the prior art.

Another object of the present invention is to provide an automatic in-line stacking apparatus for efficiently stacking a plurality of layers above and below a base and then cutting all of the layers together to a predetermined length.

Yet another object of the present invention is to provide an improved method for automatic in-line stacking of a plurality of layers above and below a base and then cutting all of the layers together to a predetermined length.

Other objects and advantages of the present invention will be made more apparent hereafter.

### SUMMARY OF THE INVENTION

In one aspect, this invention is concerned with apparatus for automatic in-line forming of a material stack comprising first feeding means for feeding a base to a predetermined position, second feeding means for feeding a first layer from a first roll onto one surface of the base, third feeding means for feeding a second layer from a second roll to the opposite surface of the base, fourth feeding means for feeding a third layer onto the first layer, moving means for moving the base, the first layer, the second layer and the third layer to a cutting station, and cutting means at the cutting station for cutting the first layer, the second layer and the third layer together to form the desired material stack with the base between the first and second layers.

In another aspect, this invention is concerned with a method of automatic in-line forming of a material stack comprising the steps of feeding a base to a predetermined position, simultaneously feeding a first layer from a first roll for placement on one side of the base in sheet form, simultaneously feeding a second layer from a second roll for placement on the opposite side of the base in sheet form, moving the base in sheet form, the first layer from the first roll, and the second layer from the second roll together through a cutting station, and cutting the first layer and the second layer together to a predetermined length to form the desired stack. The base may comprise a sheet of material or it can be material from a web or roll. Further, the base may be less in width and length than the first and second layers so as to form a border about the base. Other layers can be applied on top of the first layer if desired, or needed for a specific application.

### BRIEF DESCRIPTION OF THE DRAWING

There is shown in the attached drawing a presently preferred embodiment of the present invention, wherein like numerals in the various views refer to like elements and wherein:

FIG. 1 is a side elevation view of the automatic in-line stacking apparatus of the present invention:

FIG. 2 is a plan view of the automatic in-line stacking apparatus of the present invention, illustrating the lower rolls extended outwardly for loading;

FIG. 3 is a detail view, on an enlarged scale, of the feed assembly and the cutting assembly of the present invention; and

FIG. 4 is a schematic side view of a stack comprising a base, a layer below the base and two layers above the base.

### DETAILED DESCRIPTION OF THE INVENTION

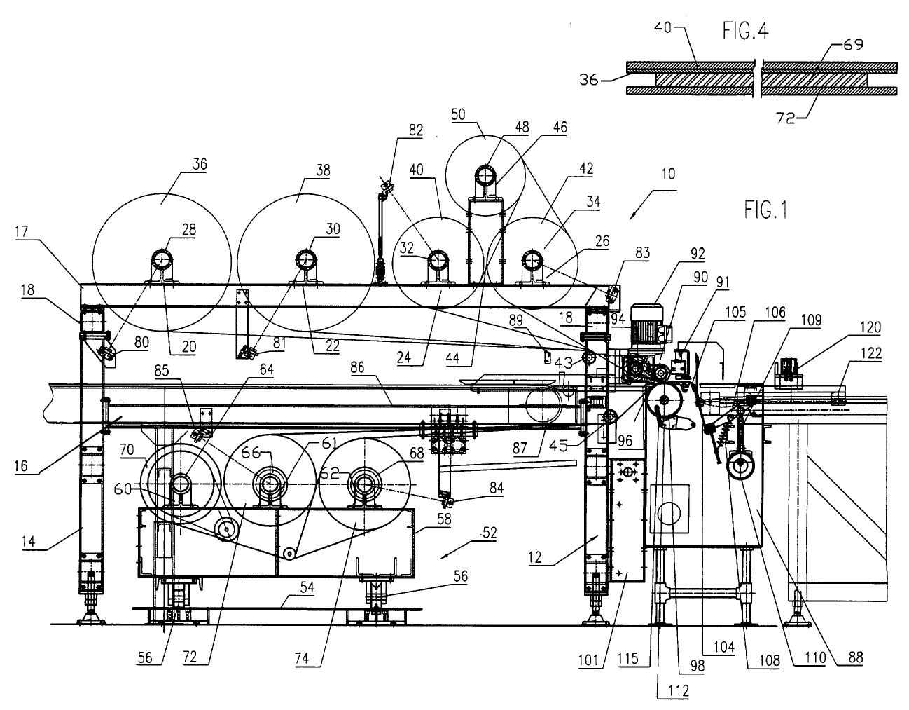

There is shown in FIG. 1, the automatic in-line stacking apparatus 10 of the present invention. The apparatus 10 comprises a main frame 12 having upright members 14 at each end supporting generally horizontal and longitudinal connecting members 16, 17 and generally horizontal and transverse connecting members 18.

Supported on the connecting members 17 are brackets 20, 22, 24 and 26, respectively, for supporting cross shafts 28, 30, 32, and 34, respectively, that carry rolls 36, 38, 40, and 42, respectively, of material to be cut and stacked. In one application, the material on roll 36 is fiberglass and the material on the roll 40 is ethylene vinyl acetate (EVA). The roll 38 could be a spare roll for fiberglass or could hold another material, for example, a dielectric material such as TEDLAR, polyvinyl fluoride. TEDLAR is a registered trademark of DuPont. The roll 42 could be a spare roll of ethylene vinyl acetate.

Extending upwardly from the connecting members 17 on each side of the main frame 12 is an extension frame 44, which carries a bracket 46. Cross shaft 48 is journalled at its ends on the brackets 46 and is adapted to carry thereon a roll 50. The roll 50 is a rewind roll to take up the paper liner from the roll of ethylene vinyl acetate on either roll 40 or roll 42.

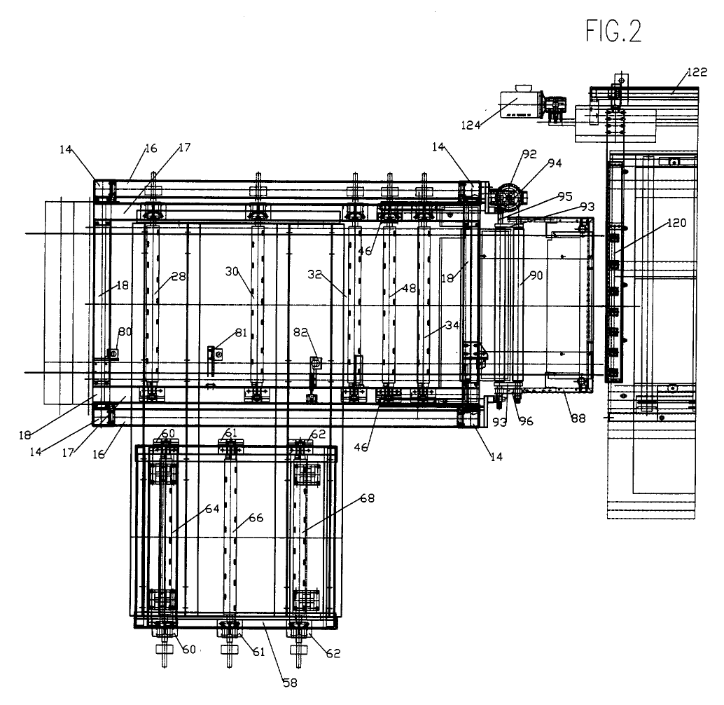

Subassembly 52 is disposed below connecting members 16, 17 of the main frame 12. The subassembly 52 includes a support 54 upon which are supported the wheels 56 of the frame 58, which enables the frame 58 to be moved from a position below the connecting members 16, 17 of the main frame 12 and between the front and rear upright members 14 to a position where the subassembly 52 is to the side of the main frame 12, as seen in FIG. 2. Carried on the frame 58 are three sets of brackets 60, 61, 62, respectively, which journal shafts 64, 66, 68, respectively, that carry rolls 70, 72, 74, respectively. Motor 76 on the frame 58 is operatively connected to the roll 70 for rotating same. For example, the roll 70 may be a rewind roll to receive material to be wound from the roll 72. The roll 72 might be for material, such as ethylene vinyl acetate, that may have a paper liner and the paper liner would be taken up on the rewind roll 70. The roll 74 could be a spare roll of ethylene vinyl acetate or a roll of another material. By moving the subassembly 52 to the position shown in FIG. 2, replacement of rolls of material from the subassembly 52 is facilitated.

Referring to FIG. 4, there is shown schematically a finished stack of material as assembled by the apparatus of the present invention. The base 69 has an ethylene vinyl acetate layer 72 below the base 69, a layer of fiberglass 36 on the base 69, and a layer of ethylene vinyl acetate 40 on top of the layer of fiberglass 36.

Carried on the main frame 12 are a number of diameter sensors 80, 81, 82, 83, 84, 85 for sensing the diameter of the roll of material with which each diameter sensor is associated to indicate when the roll is running out of material. More particularly, sensor 80 is associated with roll 36. Sensor 81 is associated with roll 38. Sensor 82 is associated with roll 40. Sensor 83 is associated with roll 42. Sensor 84 is associated with roll 74. Sensor 85 is associated with roll 72. The diameter sensors 80, 81, 82, 83, 84, 85 which are preferably, photocells, are in the main control circuit (not shown) and would stop operation of the automatic in-line stacking apparatus 10 in the event a diameter sensor sensed that the supply of material on a roll with which it was associated was about to be exhausted.

Movably supported on the main frame 12 is a conveyor 86 for moving material, for example, a base for a solar panel in sheet form, to the right, as seen in FIG. 1. The conveyor 86, which may considered to be first feeding means, may be a belt conveyor, supported on a shaft at each end and driven by a drive motor suitably connected to the front pulley 87 of the conveyor 86 in a conventional manner. A position detector 89, for example, a photocell sensor, is used to position the front edge of the base material at a predetermined position. When the front edge of the base material is sensed by the position detector 89, the conveyor 86 is actuated to advance the sheet 69 (FIG. 4) of the base material. As will be explained hereinafter, the advance of base material on conveyor 86 is coordinated with the operation of the nip roller 90 and the cooperating driven roller 98 and the knife means 102, 105 at the cutting station so that the front edge of the base sheet is spaced from the front edges of the layers of material above and below the base sheet, so as to create a border about the base sheet.

Positioned adjacent the front of the main frame 12 is a frame 88 that is secured to the main frame 12 by means of a channel 101. Carried on the main frame 12 is a suitable drive motor 92, for example, an electric or a hydraulic motor, for driving a shaft 95 through a reduction gear mechanism 94. Pivoted on the shaft 95 are a pair of arms 93 for journalling a nip roller 90. The shaft 95 is operatively connected to the nip roller 90 by a chain or belt 96. Carried on the frame 88 is a driven roller 98 which cooperates with the nip roller 90 to grip and advance the various layers of material to the right, as viewed in FIG. 1. It will be understood that the nip roller 90 can be pivoted selectively toward and moved away from the driven roller 98. The pivoting operation of the nip roller 90 is coordinated with the action of the knife means 102, 105 to assure that the layers to be cut are of the same length, thereby to compensate for different characteristics of the materials forming the various layers. The fiberglass material on roll 36, for example, is slick and slippery and the ethylene vinyl acetate material from rolls 40 and 72 tends to stretch when pulled in operation of the automatic in-line stacking apparatus of the present invention. It is desired to relax the stretch on the layers of ethylene vinyl acetate material before the cut so that the layers will all be cut to a uniform length.

Disposed adjacent to the pinch rollers, i.e., the nip roller 90 and the driven roller 98, is a paper chute 100 for supporting the layers passing from between the nip roll 90 and the driven roller 98. The nip roller 90 and the driven roller 98 comprise moving means for moving the base 69 and the various layers being fed from the rolls on the main frame 12 and the subassembly 52 to a cutting station CS to the right of the driven roller 98.

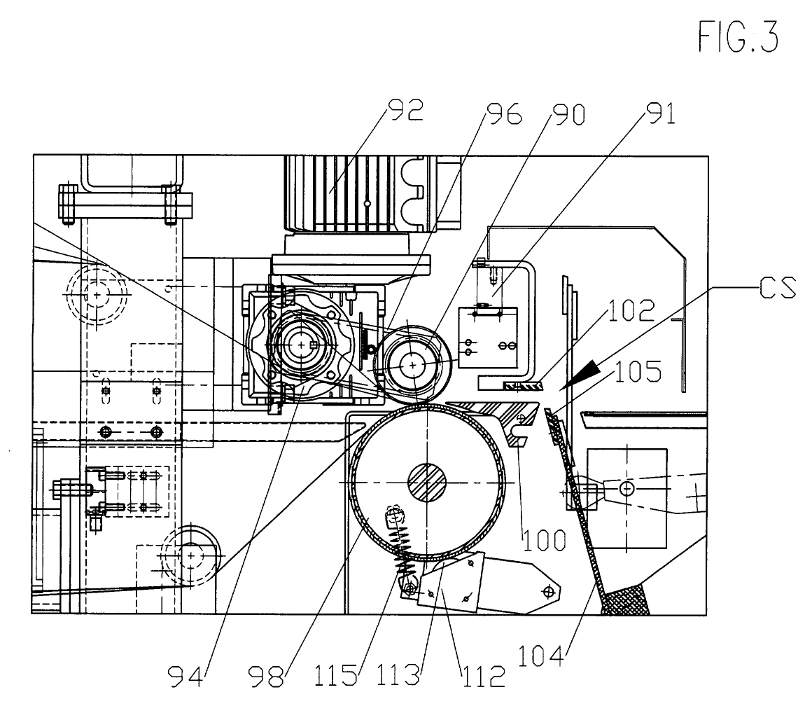

At the cutting station CS, as seen in FIGS. 1 and 3, there is mounted transversely of the frame 88 a fixed blade 102 that cooperates with a movable blade 105 for simultaneously cutting the base and the various layers of material fed from the nip roller 90 and the driven roller 98. The movable blade 105 is mounted on support 104 that is pivotally joined to an arm 106 that is pivoted at the end opposite the connection to the movable blade 98 on the frame 88. A spring 108 biases the movable blade 105 on support 104 counter clockwise, thereby urging the movable blade 105 toward the fixed blade 102 to provide a clean cut of material. The arm 109 connects the arm 106 to the drive 110, by means of which the arm 109 is moved upwardly to pivot the arm 106 and move the movable knife 105 carried on support 104 upwardly to cooperate with the edge of the fixed knife 102 and cut the material layers passing from the nip roller 90 and the driven roller 98.

Cooperating with the driven roller 98 is an encoder 112 (FIG. 3), which includes a roller 113 in contact with the surface of the driven roller 98 for measuring the circumferential length of the driven roller 98, which is correlated and essentially equal to the length to be cut. The encoder 112 is biased toward contact with the exterior surface of the driven roller 98 by a spring 115. When a predetermined circumferential length is sensed by the encoder 112, a signal is sent to the control circuit to actuate the drive 110 and move the movable knife 105 to cut the material. This will set the border, which is the distance from the lead edge of the base to the lead edge of the trimmed layers. The material feeds to the gripper 120, which clamps the stacked layers of material. The nip roller 90 is lifted away from the driven roller 98 and the gripper 120 pulls the material to the right along the guide track 122 a predetermined distance corresponding to the overall length desired for the stacked layer. The gripper 120 is operatively connected to a suitable drive 124 for reciprocating the gripper 120 on the guide track. Suitable pneumatic or the like actuators are provided for the clamps on the gripper 120. When the trailing edge of the first stack passes the sensor 89, the nip roller 90 is moved toward engagement with the driven roller 98 and the machine 12 stops and waits for the next base. The conveyor 86 will feed a succeeding base. When the second or succeeding base is sensed by the photocell sensor 89, machine operation will continue. The pinch rollers 90 and 98 will cooperate to advance material to the cutting station CS. When the sensor 91 senses the trailing edge of the first stack, a signal is sent to the control circuit to actuate the drive 110 and move the movable knife 105 to cut the first stack to a predetermined length. The gripper 120 will deposit the cut first stack on a table or a conveyor for further processing, for example, lamination of the various layers together by pressure and heat. The conveyor and lamination apparatus are not shown as they are not part of the present invention. The gripper 120 will then return to the home position, where it can grip or clamp the succeeding stack.

In operation, suitable rolls of material are positioned on the main frame 12 and on the subassembly 52. Materials from the rolls 36 and 40 are threaded over the idler 43 past the nip roller 90 and the driven roller 98. Material from the roll 72 is threaded over the idler 45 past the nip roller 90 and the driven roller 98. A cut is made at the cutting station CS to align the lead edges from the rolls 36, 40 and 72. The first feeding means, the conveyor 86, is actuated to move the base until the front edge is at a predetermined position as sensed by the sensor 89. In a solar panel application, the base is normally a composite discrete sheet. It is intended that there be a border about the base, hence the base is spaced from the front edges of the material from the rolls 36, 40, and 72 by a predetermined distance corresponding to the width of the border.

Material from the roll 36 is fed onto the top surface of the base. Material from the roll 72 is fed to the bottom surface of the base. Material from the roll 40 is fed onto the top of the layer from the roll 36. The nip roller 90 cooperates with the driven roller 98 to move the base, the first layer from roll 36, the second layer from roll 72, and the third layer from the roll 38 through the cutting station CS to the gripper 120, which clamps the lead edges of the stacked layers of material. The gripper 120 in the present application is essentially a cantilevered arm having suitable pneumatically or the like actuated clamps thereon for gripping the layers of material and pulling them to the right as seen in FIGS. 1 and 2 when actuated. The encoder 112 is in contact with the surface of the driven roller 98. The encoder 112 is biased toward contact with the exterior surface of the driven roller 98 by a spring 115. When a predetermined circumferential length is sensed by the encoder 112, a signal is sent to the control circuit to actuate the drive 110 and move the movable knife 105 to cut the material and set the predetermined border. The material is fed to the gripper 120, which clamps the stacked layers of material. The nip roller 90 is pivoted away from the driven roller 98 and the gripper 120 pulls the stacked layers to the right along the guide track 122 a predetermined distance corresponding to the overall length desired for the stacked layer. The gripper 120 is operatively connected to a suitable drive 124 for actuating the gripping or clamping and for reciprocating the gripper 120 on the guide track. When the trailing edge of the first stack passes the sensor 89, the nip roller is moved toward the driven roller 98 and the machine 12 stops and waits for the next base. The conveyor 86 will feed a succeeding base. When the second or succeeding base is sensed by the photocell sensor 89, the operation will continue. The nip roller 90 and the driven roll 98 will cooperate to feed material to the cutting station CS. When the sensor 91 senses the trailing edge of the first stack, a signal is sent to the control circuit to actuate the drive 110 and move the movable knife 105 to cut the first stack to a predetermined length. The gripper 120 will deposit the cut first stack on a table or a conveyor for further processing and the gripper 120 will then return to the home position, where it can grip or clamp the succeeding stack.

The invention in one aspect is characterized by apparatus for automatic in-line forming of a material stack comprising first feeding means for feeding a base to a predetermined position, second feeding means for feeding a first layer from a first roll onto one surface of the base, third feeding means for feeding a second layer from a second roll to the opposite surface of the base, fourth feeding means for feeding a third layer onto the first layer, moving means for moving the first layer, the second layer and the third layer to a cutting station, and cutting means at the cutting station for cutting the first layer, the second layer and the third layer together to form the desired material stack.

The invention in another aspect is characterized by a method of automatic in-line forming of a material stack comprising the steps of feeding a base in sheet form or from a roll of material to a predetermined position, simultaneously feeding a first layer from a first roll for placement on one side of the base, simultaneously feeding a second layer from a second roll for placement on the opposite side of the base in sheet form, moving the base in sheet form, the first layer from the first roll, and the second layer from the second roll together through a cutting station, and cutting the base, the first layer and the second layer together to a predetermined length to form the desired stack.

Persons skilled in the art will recognize that accessories can be added to the automatic in-line stacking apparatus to accomplish additional functions. For example, one or more slitting knives can be disposed on the main frame 12 to cut the base and layers to be stacked thereon longitudinally. By using one slitting knife, the base and the layers to be stacked can be cut into two longitudinal portions. The slitting knife can be positioned to cut the base and layers to be stacked thereon in half equally or in two portions with different widths. Punches or perforators could be added to the automatic in-line stacking apparatus if it were desired to make holes or slots in the base and the layers to be stacked.

While we have shown a presently preferred embodiment of the invention, it will be apparent to persons skilled in the art that the invention may be otherwise embodied within the scope of the following claims.

We claim:

1. A method of automatic in-line forming of a material stack comprising the steps of feeding a base in sheet form to a predetermined position, simultaneously feeding a first layer from a first roll for placement on one side of the base in sheet form, simultaneously feeding a second layer from a second roll for placement on the opposite side of the base in sheet form, moving the base in sheet form, the first layer from the first roll, and the second layer from the second roll together through a cutting station, and cutting the first layer and the second layer together to a predetermined length to form the desired stack.

2. The method of claim 1 wherein the base is flexible.

3. The method of claim 1, wherein the first layer is made from fiberglass.

4. The method of claim 3, wherein the second layer is made from an ethylene vinyl acetate (EVA) material.

5. The method of claim 1, including the steps of simultaneously feeding a third layer from a third roll onto the said one side of the base in sheet form, simultaneously feeding the base in sheet form, the first, second and third layers, and cutting the first, second and third layers together to a predetermined length to form the desired stack.

6. The method of claim 5, wherein the third layer is made from an ethylene vinyl acetate (EVA) material.

7. The method of claim 5, including the steps of simultaneously feeding a fourth layer from a fourth roll onto the said one side of the base in sheet form, simultaneously feeding the base in sheet form, the first, second, third and fourth layers together to a predetermined length to form the desired stack.

8. The method of claim 6, wherein said one side is the top side of the base in sheet form and said opposite side is the bottom side of the base in sheet form.

9. A method for automatic in-line forming of a solar panel stack comprising the steps of feeding a base in sheet form to a predetermined position, simultaneously feeding a base layer from a roll onto one side of the base in sheet form, simultaneously feeding a first encapsulating layer from a roll onto the other side of the base in sheet form, simultaneously feeding a second encapsulating layer onto the one side of the base in sheet form, moving the base in sheet form, the base layer and the first and second encapsulating layers together through a cutting station, and cutting the base layer the first and second encapsulating layers together to a predetermined length to form the desired stack, with the base in sheet form being disposed between the base layer and the first encapsulating layer.

10. The method of claim 9, including the steps of moving the base in sheet form, the base layer and the two encapsulating layers by pinch rollers to a gripper mechanism, and gripping the base layer and the encapsulating layers, separating the pinch rollers, and pulling the base, the base layers and the encapsulating layers a predetermined distance corresponding to the length desired for the stack, then cutting the base layer and the two encapsulating layers to the desired length to form the desired stack.

11. Apparatus for automatic in-line forming of a material stack comprising first feeding means for feeding a base to a predetermined position, second feeding means for feeding a first layer from a first roll onto one surface of the base, third feeding means for feeding a second layer from a second roll to the opposite surface of the base, fourth feeding means for feeding a third layer onto the first layer, moving means for moving the base, the first layer, the second layer and the third layer to a cutting station, and cutting means for cutting the first layer, the second layer and the third layer together to form the desired material stack.

12. The apparatus of claim 11, wherein the moving means comprise a pair of pinch rolls cooperating with one another.

13. The apparatus of claim 11, wherein the pinch rolls are movable toward and away from one another and the moving means include gripper means for pulling the layers a predetermined distance corresponding to the desired length of the finished stack when the pinch rolls are separated.

14. Apparatus for automatic in-line forming of a material stack comprising a main frame, a first roll on the main frame from which a base material is fed to a predetermined position, a second roll from which a first layer of material is fed onto one surface of the base material, a third roll from which a second layer of material is fed to the opposite surface of the base, a fourth roll from which a third layer is fed onto the first layer, moving means for moving the base material, the first layer, the second layer and the third layer to a cutting station, and cutting means at the cutting station for cutting the first layer, the second layer and the third layer together to form the desired stack of material on both sides of the base material.

15. The apparatus of claim 14, wherein the moving means comprise a nip roller cooperating with a driven roll for gripping the material layers and moving them to the cutting station.

16. The apparatus of claim 15, wherein the moving means includes a drive motor for the nip roller.

17. The apparatus of claim 14, wherein the cutting means includes a movable blade actuated to cut the stacked base material and layers at predetermined intervals.

18. The apparatus of claim 15, wherein the moving means includes a gripper means for pulling the layers a predetermined distance corresponding to the desired length of the finished stack when the nip roller and driven roller are moved from one another.
